(19) United States
(12) Patent Application Publication
(10) Pub. No.: US 2017/0105368 A1
(43) Pub. Date: Apr. 20, 2017

(54) Hybrid Hydroponic Plant Growing Systems

(71) Applicant: Edward L. Mehrman, Sarasota, FL (US)

(72) Inventor: Edward L. Mehrman, Sarasota, FL (US)

(21) Appl. No.: 15/294,662

(22) Filed: Oct. 14, 2016

Related U.S. Application Data
(60) Provisional application No. 62/241,901, filed on Oct. 15, 2015.

(51) Int. Cl. A01G 25/02; B05B 1/02; A01G 31/06; A01G 25/16; A01G 9/24

(52) U.S. Cl. CPC A01G 25/023; A01G 25/165; A01G 9/247; A01G 9/246; A01G 31/06; B05B 1/02; A01G 2031/006

(57) ABSTRACT

Hybrid hydroponic plant growing systems are designed specifically for urban home, community and small farm gardening without the need for arable soil or broadcast irrigation. The innovative hybrid hydroponic systems provide a “hybrid” growing environment including a limited, containerized amount of soil-like growing media combined with soluble fertilizer creating a hydroponic nutrient solution. The use of containerized growing media allows the units to be utilized regardless of the availability of arable soil, irrigation water, or runoff capacity. Multiple hydroponic techniques, such as drip system, nutrient wicking, ebb-and-flow, and/or deep water culture are combined to optimize plant nutrition at different stages of plant growth. Incremental fertilization, water monitoring, and drain systems are designed for easy use by non-professional gardeners. Water recirculation minimizes water use and fertilizer runoff. The units are easily adapted to solar and other off-grid power techniques.

### RELATED APPLICATION

This application claims priority to U.S. Provisional Patent Application Ser. No. 62/241,901 entitled “Trizome Grow System” filed Oct. 15, 2015, which is incorporated by reference.

### TECHNICAL FIELD

The present invention relates to the field of hydroponic plant growing systems and, more particularly, to a hybrid hydroponic plant growing system utilizing containerized growing media and recirculating nutrient solution.

### BACKGROUND

For centuries, home gardens have been an integral component of family farming and local food systems. Food production on small plots adjacent to human settlements is one of the oldest and most enduring forms of cultivation. Due to urbanization, however, the ability to have home gardens and small farms in urban communities is often hampered by a lack of non-contaminated and arable land or irrigation. The skill set required to “grow your own food” and the associated satisfaction and innovation that results from widespread individual participation in food production is being lost to less nutritional processed, “convenience” products. And these are the very food products that contribute to obesity and other diet-related diseases in children, youth and adults alike.

The potential for home, community and small farm vegetable gardening in urban environments is enormous. There are over two hundred million residents of urban areas in the United States alone. It is estimated that over 54% of the world's population lives in urban areas. Many of these people live in communities not suitable for even small vegetable gardens. In recent years, the interest in urban gardening and farming has been on the rise with good reason, including the affordability of locally grown fresh produce along with its health and socio-economic benefits. Urban food production has been known to operate at a professional farm scale producing high quality fresh foods on relatively small amounts of space. These techniques generally include aquaculture, hydroponics, aquaponics and greenhouses. Yet smaller scale growing systems designed for non-professional gardeners have not gained widespread acceptance in urban settings that lack arable soil and irrigation. The potential to expand urban agriculture therefore remains enormous.

Hydroponics is an ancient science, perhaps dating back to the Hanging Gardens of Babylon, in which plants are grown in a nutrient solution rather than soil. A variety of hydroponic techniques have been developed including top-feed drip systems, water spray systems, aerosol spray systems (also referred to as aeroponics), nutrient film technique (NFT), wicking systems, deep water culture, raft culture, ebb-and-flow techniques, and systems utilizing fish waste as the plant nutrient (sometimes referred to as aquaponics or aquaculture). Large rafts, vertical cascades, and matrix systems have been developed to feed a large number of plants from a single water and nutrient supply system. Hydroponic systems have also incorporated a range of growing media, such as pebbles, lava rock, expanded clay, perlite, vermiculite, and so forth.

While successful in some situations, hydroponic systems suffer from a number of challenges that have impeded its adoption or widespread success in a number of other applications. First, the nutrient, water, light, physical support and other needs of plants vary greatly over the plant's lifecycle. This makes it difficult for an integrated mechanical system to meet the needs of a plant as those needs change dramatically over the plant's life cycle. As a result, successful hydroponic systems have generally been limited to a small class of plants, such as herbs, lettuce and tomatoes, that grow quickly and well in a nutrient solution. Second, sophisticated hydroponic systems are sufficiently expensive to limit their application to commercial settings. Smaller scale hydroponic systems suitable for home and small community gardens have experienced very limited success, mainly limited to a few crops that readily grow to harvest maturity in nutrient solutions.

Advocating urban gardening sounds easy, but significant technical hurdles have prevented hydroponic growing systems from experiencing large scale success. Only a few types of plants grow well in nutrient solution alone. Maintenance of proper pH and nutrient concentration over a growing season can be particularly challenging in hydroponic systems using recirculating water. Alkaline salts present in irrigation water tend to accumulate in the nutrient solution elevating pH over time. The quantity of recirculating water in the system greatly affects the rate at which salts accumulate. The character of the irrigation water and the evaporation rate also impact the salt accumulation rate. Water monitoring, pH maintenance, nutrient concentration maintenance, and the need for system flushing are major factors effecting ease of use. Conventional hydroponic growing systems have not met the basic characteristics needed for successful commercial deployment in non-professional growing in urban settings. These characteristics generally include (a) efficacy in growing a range of vegetables considered desirable for home and local consumption, (b) ease of use suitable for non-professional growers in home and urban settings, (c) compatibility with a range of currently available fertilizers, and (d) economically feasible price points for typical non-professional home and urban growers.

There is, therefore, a continuing need for improved hydroponic systems. More specifically, there is a need for cost effective hydroponic systems suitable for urban home and small community gardens, as well as commercial systems, capable of growing plants other than the relatively small class of crops that readily grow to harvest maturity in nutrient solutions alone.

### SUMMARY OF THE INVENTION

The problems described above are addressed through hybrid hydroponic plant growing systems designed specifically for urban home, community and small farm gardening without the need for arable soil or broadcast irrigation. The innovative systems provide a “hybrid” growing environment including a limited, containerized amount of soil or soil-like growing media combined with a nutrient solution or soluble fertilizer that dissolves to create a hydroponic nutrient solution. Containerized growing media allows a wide range of plants to be grown without the need for arable soil and irrigation. Recirculation of nutrient solution avoids broadcast irrigation to minimize water use and prevent fertilizer runoff. Multiple hydroponic techniques, such as drip system, nutrient wicking, ebb-and-flow, and/or deep water culture may be combined to optimize plant nutrition at different stages of plant growth. Incremental fertilization, water monitoring, and drain systems are designed for ease of use by typical non-professional gardeners. The units are easily adapted to solar and other off-grid power techniques.

The specific techniques and structures for implementing particular embodiments of the invention, and thereby accomplishing the advantages described above, will become apparent from the following detailed description of the embodiments and the appended drawings and claims.

### BRIEF DESCRIPTION OF THE DRAWINGS

FIG. 1 is a conceptual diagram of a first illustrative embodiment known as the “Homer” hybrid hydroponic unit.

FIG. 2 is an additional conceptual diagram of the Homer unit.

FIG. 3 is a conceptual diagram of a grow sleeve for the Homer unit.

FIG. 4 is an assembly diagram of the grow sleeve.

FIG. 5 is an end view of a topper housing a number of grow sleeves.

FIG. 6 is a side view of the grow sleeves held within the upper chamber of the Homer unit.

FIG. 7 is a side view of an illustrative example of the Homer unit.

FIG. 8 is an end view of the Homer unit.

FIG. 9 is a side assembly view of the Homer unit.

FIG. 10 is an end assembly view of the Homer unit.

FIG. 11 is a side view of the Homer unit including a trellis attachment.

FIG. 12 is an assembly side view of the trellis attachment.

FIG. 13 is conceptual top view of a shelf for the Homer unit.

FIG. 14 is conceptual side view of the shelf.

FIG. 15 is conceptual end view of the shelf.

FIG. 16 is conceptual top view of a shelf for the Homer unit.

FIG. 17 is a side view conceptual diagram of another illustrative embodiment of the Homer unit.

FIG. 18 is an end view of the alternative Homer embodiment.

FIG. 19 is a top view of the alternative Homer embodiment.

FIG. 20 is a conceptual diagram of a second type of hybrid hydroponic unit known as the “Titan” unit.

FIG. 21 is an end view conceptual diagram of the Titan unit.

FIG. 22 is a conceptual diagram of a three-stage drain for the hybrid hydroponic systems.

FIG. 23A is a conceptual illustration of a root raft at a lower water level in an ebb-and-flow chamber of a hybrid hydroponic system.

FIG. 23B is a conceptual illustration of the root raft at a higher water level in the ebb-and-flow chamber of the hybrid hydroponic system.

### DETAILED DESCRIPTION OF ILLUSTRATIVE EMBODIMENTS

Embodiments of the invention may be realized in innovative hybrid hydroponic growing units that utilize containerized growing media and multiple hydroponic techniques to enhance plant growth at different stages of plant development. The use of containerized growing media allows the units to be utilized regardless of the availability of arable soil or irrigation water. Multiple hydroponic techniques, such as drip system, nutrient wicking, ebb-and-flow, and/or deep water culture are combined to optimize plant nutrition at different stages of plant growth. The units may use any type of fertilizer, such as conventional solid fertilizer pellets or powder, controlled release fertilizer prills, hydroponic nutrient solution, organic solids, compost, “tea bags” containing any of a wide variety of typically organic materials, or any other suitable fertilizer. Incremental fertilization, water monitoring, and drain systems are designed for easy use by non-professional gardeners. Water recirculation minimizes water use and prevents fertilizer runoff. The units, which are easily adapted to solar and other off-grid power techniques, meet a number of objective considered important for urban gardening including (a) efficacy in growing a range of vegetables considered desirable for home and local consumption, (b) ease of use suitable for non-professional growers in home and urban settings, (c) compatibility with a range of currently available fertilizers, and (d) economically feasible price points for typical non-professional home and urban growers.

The most prominent benefits of the hybrid hydroponic units include improving nutrition in urban environments, improving food security in and across the nation, relieving childhood obesity through increased consumption of fresh vegetables, diversifying the nation's food production away from mono-crop agribusiness, increasing urban incomes through locally grown produce, freeing scarce household income from the food budget to other priorities, repurposing abandoned and underutilized urban locations to vegetable production, reducing water and fertilizer use for vegetable production, reducing soil erosion and fertilizer runoff from vegetable production, developing food production systems amenable to off-grid power, and developing food production systems that can be exported to third world communities.

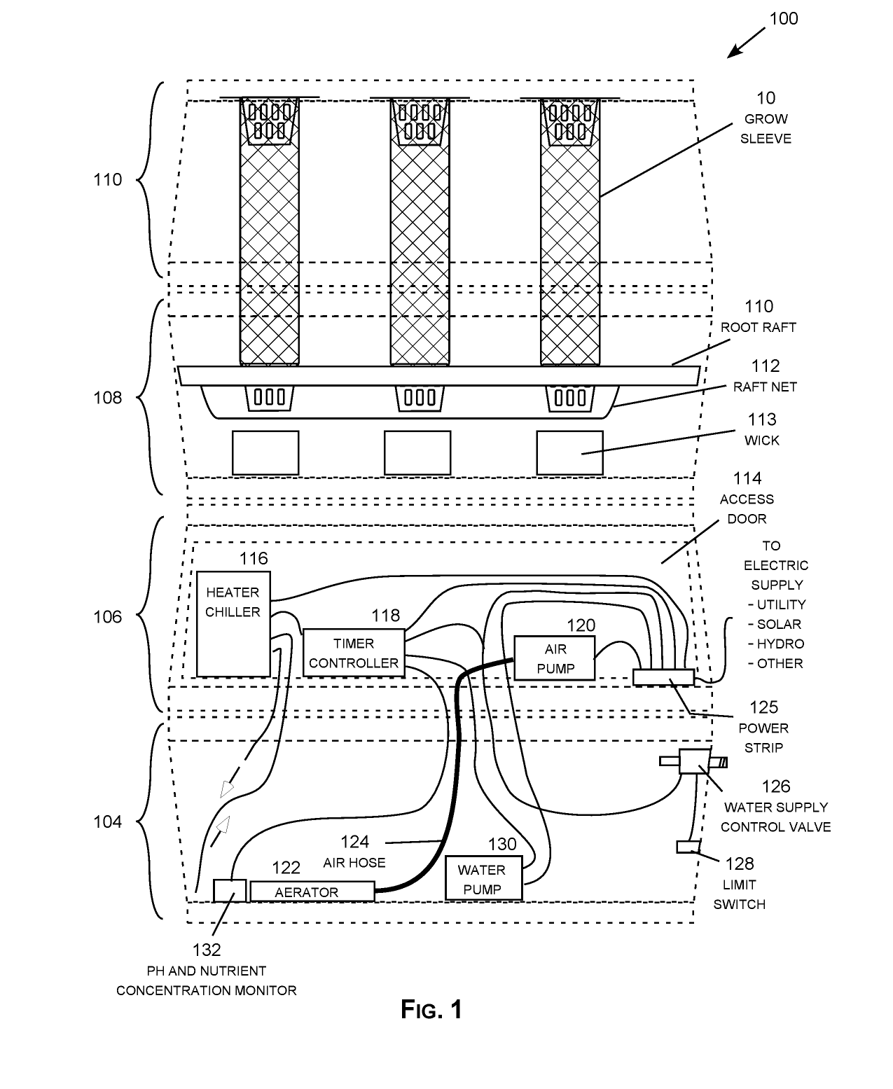

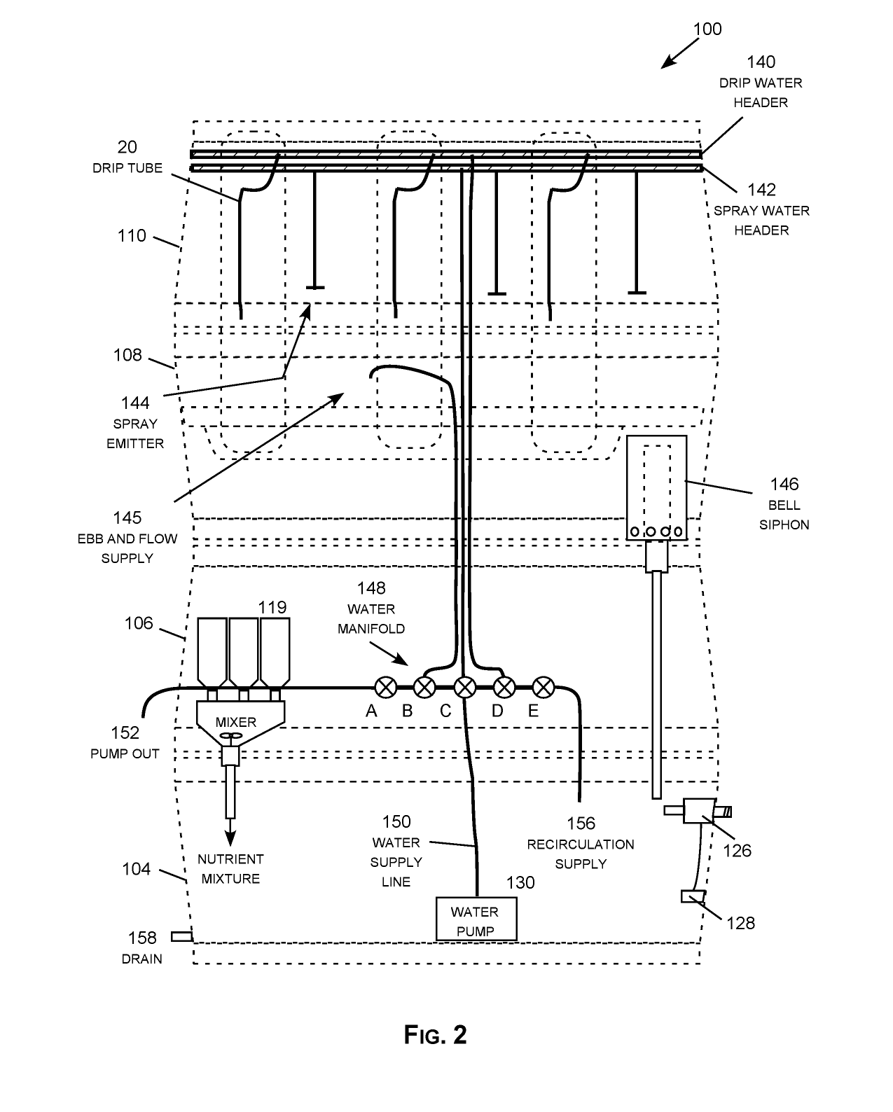

Turning now to the drawings, a number of embodiments are illustrated in which like element numerals refer to similar components. Where an illustration shows multiple instances of the same component, only one or a few of the instances may be enumerated to avoid cluttering the figure. FIGS. 1-2 are conceptual illustrations of a first type of hybrid hydroponic unit known as the “Homer” unit 100. The Homer unit is particularly suitable for severely limited spaces, such apartment balconies, decks, courtyards, decks, small yards, small rooftop locations, and so forth. FIG. 1 focuses on the electrical components while FIG. 2 focuses on the hydraulic components.

The Homer unit consists of four high-density foam boxes (also referred to as sections, containers or chambers) 104, 106, 108 and 110 stacked on top of each other. The bottom box 104 has its open side facing up, the second box from the bottom 106 has its open side facing down, the third box from the bottom 108 has its open side facing up, and the upper box 110 has its open side facing down. The bottom box forms a pump tank 104 (water reservoir section) holding a water pump 130 and an air-supplied aerator, such as an air stone 122 typically used in aquariums. As an option, the air-supplied aerator may be replaced by a diffuser supplied by a water tube, which may eliminate the need for an air pump. As another option to automate water level maintenance, a water supply control valve 126 and limit switch 128 may be used to automatically refill the pump tank 104 when the water remains below a desired level for a predetermined period of time. For example, the predetermined period of time used to trigger a water refill may be two or three multiples of the ebb-and-flow cycle to prevent the normal ebb-and-flow cycle from triggering a water refill.

The second box from the bottom is a normally dry controller section 106 holding the electric components including a timer-controller 118 and an air pump 120. An air tube 124 connects the aerator 122 in the pump tank 104 to the air pump 120. The box forming the controller section 106 typically includes screened air vents to allow air circulation while keeping out water, dust, insects and animals. An access door 114 allows manual access to the components inside the controller section. As an additional option, the controller section 106 may also contain a heater-chiller 116, which may be controlled manually, by an internal thermostat, or by the timer-controller 118 to automatically control the water temperature. One or more cooling fans, which may be controlled based on the temperature inside the controller section 106, may be included to increase air circulation within the section. In a solar powered embodiment, the cooling fans may run whenever there is sufficient sunlight to energize the solar panel. The controller section 106 may also contain a power strip 125 used to connect the electric equipment to an electric power supply, such as a household 120 Volt electric service, a solar panel, electric generator or other electric power supply.

The third box from the bottom is an ebb-and-flow section 108 regulated by a bell siphon 146 shown in FIG. 2. A root raft 110 including a root net 112 may be placed in the ebb-and-flow section 108. The root raft 110 floats on the water during the ebb-and-flow action of the water in this section. The root raft 110 helps to retain the roots to prevent or at least slow the roots from growing into the area below the root raft. One or more wicks 113 may be positioned below the root raft 110 in the ebb-and-flow section 108. “Tea bags” or other types of fertilizer may be placed in the root net 112 or in the wicks 113. Organic fertilizer solids should generally be placed in some type of filter bag to prevent fouling the water pump and clogging the emitters. The aerator 122 or a second aerator also may be placed in the ebb-and-flow section 108.

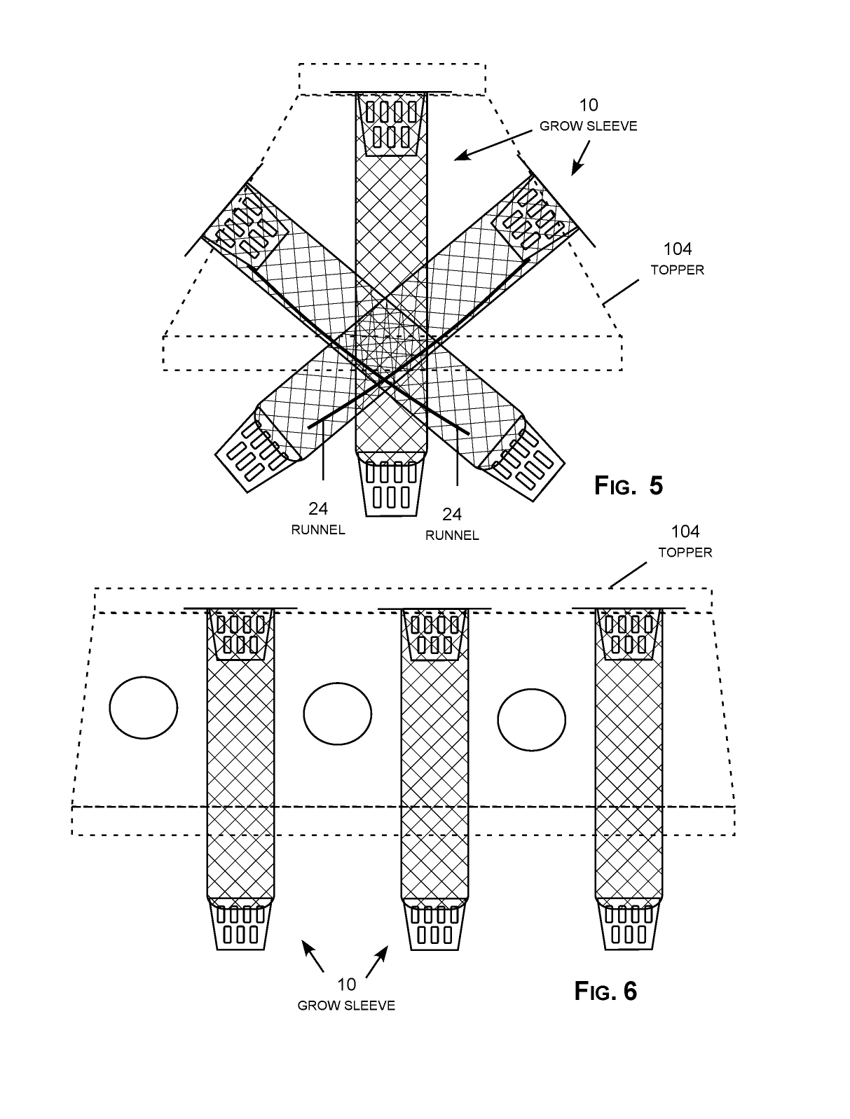

The upper box is an air pruning section 110 housing a number of “grow sleeves” 10 containing grow media, which are described in detail with reference to FIGS. 4-5. The grow sleeves housed in the air pruning section 110 may include sleeves have different sizes. For example, larger grow sleeves may be positioned in the top of the section, while smaller grow sleeves may be positioned in the sides of the section. The larger grow sleeves may be used to grow larger plants, such as tomatos and peppers, while the smaller grow sleeves may be used to grow smaller plants, such as lettuce, kale and herbs. The upper boxes, also referred to a “toppers,” may have different shapes specifically designed to house different types of plants (e.g., tomato toppers, lettuce toppers, herb toppers, flower toppers, melon toppers, and so forth) and different combinations of plants (tomato and lettuce toppers, pepper and herb toppers, melon and flower toppers, and so forth).

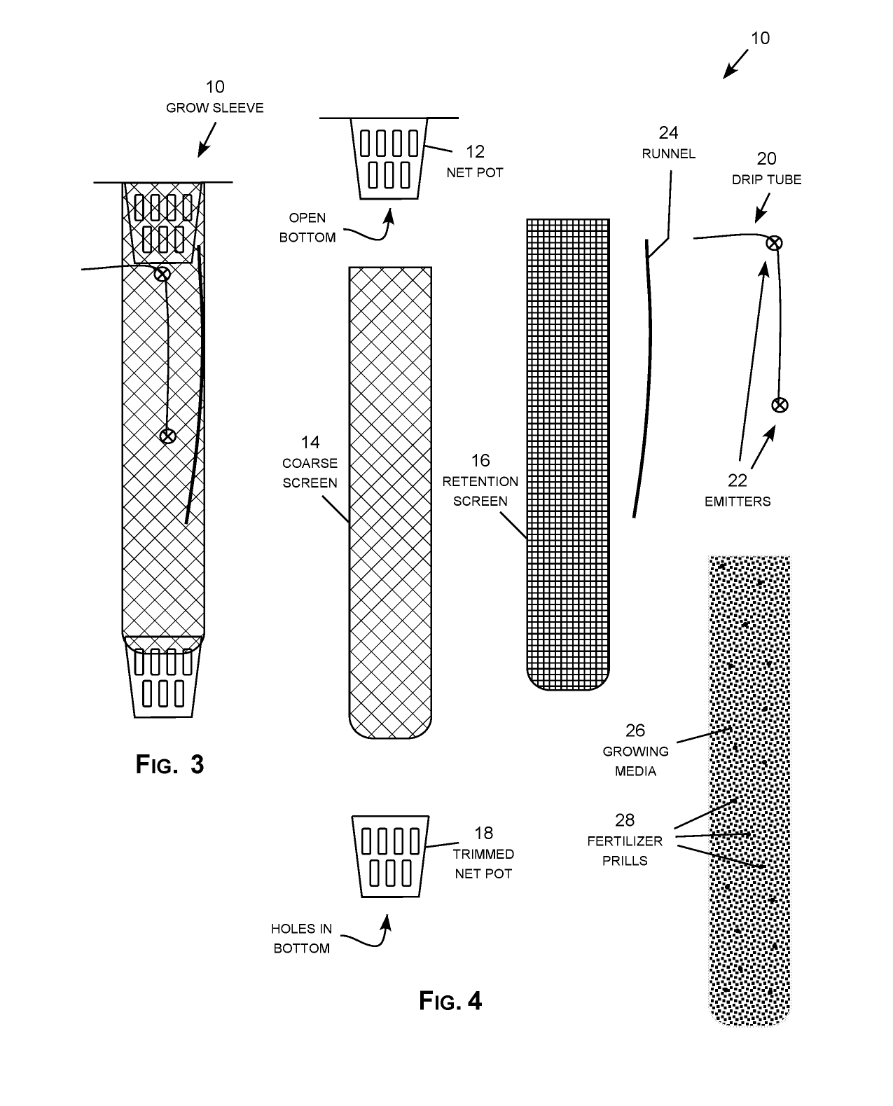

FIG. 2 shows the hydraulic components of the Homer unit 100. The air pruning section 110 houses a drip water header 140 that supplies direct injection drip lines 20 that are positioned in the grow sleeves, as described in greater detail with reference to FIGS. 3-4. The air pruning section 110 also houses a spray water header 142 that supplies a number of spray emitters 144 positioned alongside the grow sleeves. These emitters can be water spray, aeroponic, or any other type of emitters as desired. The spray emitters 144 and the drip tubes 20 may be controlled separately allowing the hydration profile to be adjusted as the plants growing in the unit mature. For example, the drip tubes 20 may be primarily used during early root development, and the spray emitters 144 may be primarily used during later root development once the roots grow through the sleeves.

The ebb-and-flow section 108 houses a bell siphon 146 that periodically drains the ebb-and-flow section to the pump tank 110. In some cases, the roots can grow past the root raft into water at the bottom of the ebb-and-flow tank. This adds a third “deep water culture” nutrition technique to the system to support the mature plant stage. The pump tank 104 houses the water pump 130, a drain 158, and an optional water supply valve 126 regulated by a limit switch 128. The water pump 130 feeds a water supply tube 150 connected to the water manifold 148 located in the controller section 106.

In this particular embodiment, the water manifold 148 includes five valves. A first valve A controls water flow to a pump-out tube 152 that can be used to pump water out of the unit as desired. A second valve B controls water flow to an ebb-and-flow supply tube 154 that supplies water to the ebb-and-flow section 108. The second valve B can be adjusted to control the ebb-and-flow cycle. The flow rate of the ebb-and-flow supply tube 154 should be much slower than the drain rate of the bell siphon 146 to allow the bell siphon to periodically evacuate and refill the ebb-and-flow section 108. A third valve C controls water flow to spray water header 142 that supplies spray water emitters 144 in the air pruning section 110. A fourth valve D controls water flow to a drip water header 140 that supplies direct injection drip tubes 20 positioned in the grow sleeves 10. The valves C and D allow the spray emitters 144 and the drip emitters 20 to be controlled separately allowing the hydration profile to be adjusted as the plants growing in the unit mature. A fifth valve E controls water flow to a recirculation tube 156 that can be used to return water to the pump tank 104.

As another option, the controller section 106 may also contain a nutrient delivery unit 119, which may also be controlled manually or by the timer-controller 118. The nutrient delivery unit 119 includes a number of containers and a mixer. The nutrient supply containers may hold nutrient solutions, soluble solid fertilizer, pH modifier, and other additives. In advanced units with a nutrient delivery unit 119, a pH and nutrient concentration monitor 132 may be located in the pump tank 104 and operationally connected to the timer-controller 118 to allow automated pH and nutrient concentration control. The nutrient delivery unit 119 includes multiple containers to prevent the contents from reacting with each other prior to delivery into the unit. The containers typically include nutrients and may include a component to adjust pH, such as vinegar. Other types of additives may be stored in the nutrient delivery unit 119 and delivered into the unit, such as additives to be introduced at the fruiting or flowering stage to influence or become infused into the fruit or flowers. These additives may include, for example, sugars, dyes, capsaicin, flavorings, anti-allergenic agents, pesticides, herbicides, medicines, hormones, genetic components, or other additives to be exposed to the plants growing in the unit. These additives may be introduced to benefit the plant, to benefit pollinators, to benefit humans or animals consuming the plants, or to have other desired effects. The hybrid hydroponic units are particularly well suited to this type of application because precise dosages of additives can be introduced at precise times or schedules, while the additives are recirculated within the unit without running to waste, runoff or exposing the solution containing the additive to other plants or animals in the environment.

FIG. 3 is a conceptual diagram of an example grow sleeve 10 for the Homer unit and FIG. 4 is an assembly diagram of this version of the grow sleeve. The grow sleeve 10 includes a net cup 12 with positioned at the top of the grow sleeve. The net cup 12 has an open bottom covered by a retention screen for holding a plant at the top of the grow sleeve. The retention screen is selected to prevent the growing media in the net cup from readily falling though the net cup when a starter plant is initially placed in the net cup. The open bottom allows the plant roots to readily grow through the bottom of the net cup down, into and through the grow sleeve 10. A coarse screen 14 provides flexible support to the grow sleeve. A retention screen 16 is placed next to the coarse screen on the inside or the outside of the coarse screen. Again, the retention screen is selected to prevent the growing media in the grow sleeve from readily falling out of the grow sleeve. A trimmed net pot 18 with holes in the bottom is typically placed at the bottom of the grow sleeve so that the trimmed net pot extends below the bottom of the coarse and retention screens. The holes in the bottom of the trimmed net pot 18 are sized to allow larger roots to grow through the bottom of the grow sleeve without allowing the grow media to fall through the sleeve. The coarse screen 14 may be looped into a cylinder with thin cable ties. The net pots 12 and 18 and the retention screen 16 may also be attached to the coarse screen with thin cable ties to hold the grow sleeve together. While a simple assembly process using off-the-shelf components has been described, any other suitable manufacturing process may be used provided that the growing media 26 is largely held in place inside the grow sleeve 10 and the roots are properly hydrated, nourished, and allowed to grow within and typically though the sides and bottom of the grow sleeve.

A direct injection drip tube 20, which may be drip tape or tube supplying a number of drip emitters 22, is located inside the grow sleeve 10, where it typically runs along the edge or is embedded within the growing media 26. A runnel 24 may be located inside the retention screen at the edge of the grow media to keep the water supplied by the drip emitters from running out the side of the grow sleeve. Growing media 26 may include soluble fertilizer solids mixed into the growing media, such as controlled release fertilizer prills 28, organic components, or other nutrients. Other additives may be mixed into the growing media as desired.

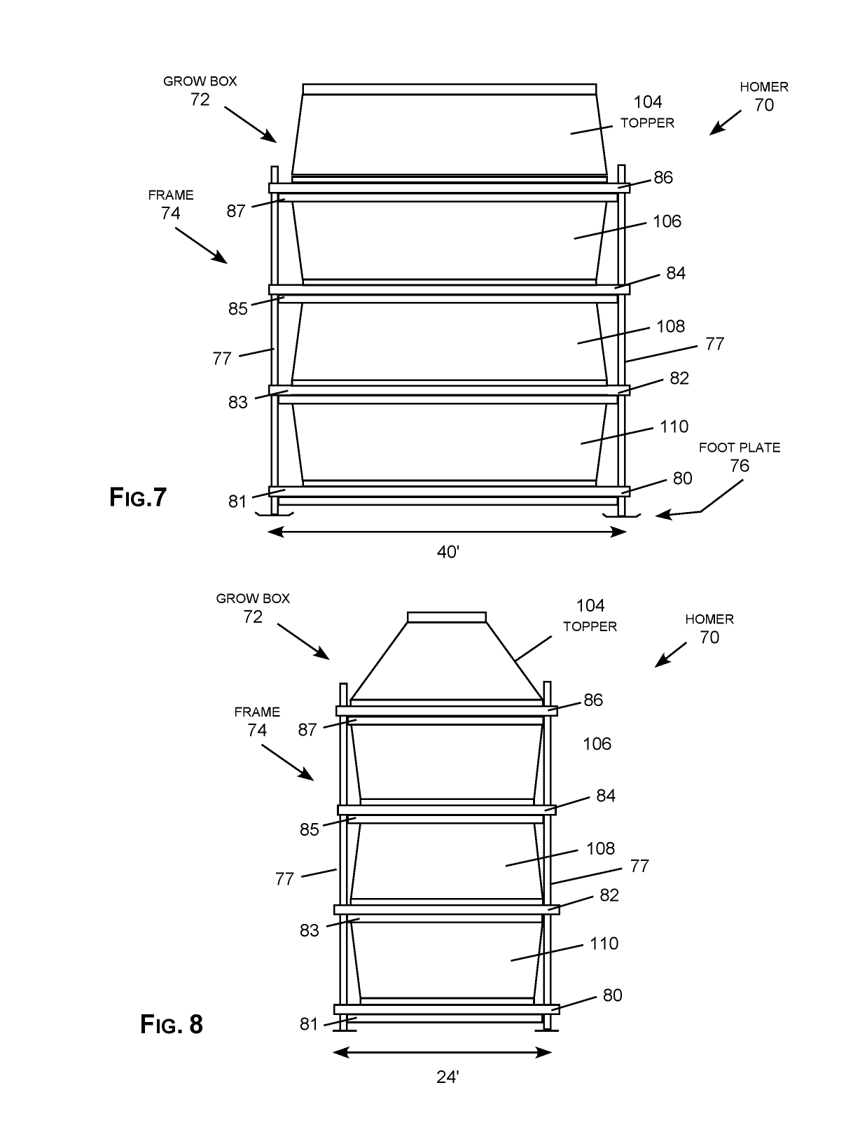

FIG. 5 is an end view of the upper chamber or topper 104 showing a number of grow sleeves held within the Homer unit. FIG. 6 is a side view of the grow sleeves held within the topper. The runnels 24 are used for grow sleeves oriented on an angle, such as sleeves housed in the side walls of the topper, as shown in FIG. 5. Vertically oriented grow sleeves housed in the top side of the topper, as shown in FIG. 6, typically do not need runnels. A section of plastic cut from a gallon (4 liter) milk jug or a tennis ball can serve as an inexpensive option for fashioning a runnel. Again, while a simple assembly process using off-the-shelf components has been described, any other suitable manufacturing process may be utilized.

Referring to FIG. 2, the drip tubes 20 placed inside the grow sleeves 10 provide direct injection hydration to the plant roots during early root development. The spray heads 144 located in the air pruning section 104 hydrate the roots as they protrude through the sleeves and continue to grow. Roots reaching through the grow sleeves into the air environment tend to experience slowed growth known as “air pruning.” This phenomenon along with direct injection irrigation inside the grow sleeves promotes rapid root development within, down and through the bottom of the grow sleeve into the ebb-and-flow tank. Fertilizer may be included in nutrient solution, mixed into the growing media in the grow sleeves (e.g., controlled release fertilizer prills), placed onto the net in the root raft (e.g., organic fertilizer solids), placed in “tea bags” positioned on the root raft, in wicks located below the root raft or in the pump take (e.g., compost tea, worm tea), or in any other suitable location. However applied, the fertilizer ultimately becomes dissolved in the water recirculating within the unit. Recirculation of the water within the unit prevents the fertilizer from running to waste, which minimizes water and fertilizer use, avoids fertilizer runoff, and prevents soil erosion. Spent solution and growing media at the end of a growing season can be added to a compost pile. This version of the Homer unit will hold about eight gallons (30 liters) of water in normal operating conditions.

The Homer unit utilizes the irrigated air-pruning grow sleeves 10 to foster early-stage root development through direct injection drip irrigation and low pressure water spray heads. The grow sleeve 10 provides a highly effective and efficient way to grow plants combining the benefits of soilless hydroponics with soil-based growing systems. The irrigated aspect of the grow sleeve provides directed drip irrigation directly to the root as they propagate within the grow sleeve. The air-pruning aspect of the grow sleeve promotes rapid root development from early seedling, down and through the sleeve, into the ebb-and-flow deep water culture. The grow sleeve contains a soil grow medium or a soilless grow medium, or a combination of soil and soil-like products. For example, a sophisticated soil-like growing media may be utilized. A mixed soil-like media may be used instead of natural soil to avoid a range of pathogens that naturally occur in soil. This media is meant to imitate the many features of high quality soil, such as its texture, density, and ability to hold water. Encouraging results have been obtained with a growing media consisting mainly of sorghum peat moss, rice hulls, expanded coco coir, and fine pine mulch. One or more fertilizer components may be mixed into the growing media, such as a precisely defined allotment of controlled release fertilizer, an allotment of mycorrhizal fungi, organic fertilizer, or other ingredients, which may be selected for the particular type of plant to be grown in the sleeve. Other materials added to the mixture may include dolomite (pH stabilizer), vermiculite (retains water and gives body), and perlite (retains water).

At the early stage of plant development, the Homer unit 10 could alternatively or additionally utilize different types of emitters or a low pressure aeroponic spray bar. The ability to adapt the unit to alternate irrigation techniques provides a robust quality encouraging future experimentation and innovation. If, for instance, the drip or spray emitters were found to be prone to clogging, the system could easily be modified to utilize top drip, drip tape, spinning spray heads, or low a pressure aeroponic spray bar as alternate irrigation techniques. In general, emitter clogging can be avoided by preventing solids from getting into the water pump. The retention screens should be sized, “tea bags” should be used to contain organic solids, and filters may be deployed in the hydraulic system to prevent solids from entering the pump. For example, the retention screens should be selected in view of the coarseness of the growing media selected, a retention screen may be located around the bell siphon inlet, and a filter may be placed at the pump intake.

As the plant grows, the roots extend down into the ebb-and-flow chamber. Nutrient containers, such as “tea bags” containing organic fertilizers, may be placed on the root raft, for example in a central net portion of the root raft. The “tea bags” may also be placed in wicks positioned below the root raft in the ebb-and-flow chamber to encourage fertilizer to be wicked up from the bottom of the ebb-and-flow chamber. This wicking action, often referred to as “Dutch wicks,” allows nutrients released by the ebb-and-flow action to be wicked to the roots, while also allowing the nutrients to be filtered down into the reservoir for recirculation. This creates water and nutrient management and conservation by recirculating these constituents within the system. The ebb-and-flow action emulates a “high and a low tide” by pumping the nutrient-rich water onto the roots in the intermediate root zone. In this version of the Homer unit, the ebb-and-flow action is accomplished by way of the bell siphon, but could alternately be run and/or reversed using the parallel active passive drain system, which is similar to the overflow drain of a sink with a manual drain at the bottom and an overflow prevention drain near the top.

As the plant reaches maturity, the roots may grow through the root raft into the water at the bottom of the ebb-and-flow tank. This adds a third “deep water culture” nutrition technique to the system to support the mature plant stage. The aerated reservoir tank adds oxygen to the water to contribute to the deep water culture in the pump tank. Should the system shut down or stop operating for any reason, the bottom pump tank has enough water in reserve to last the plants at least three days, allowing a competent operator more than enough time to correct any malfunction. Indeed, even during an extended power outage, the entire system can be sustained easily by filling the ebb-and-flow and pump tanks with a garden hose or bucket to the secondary overflow point.

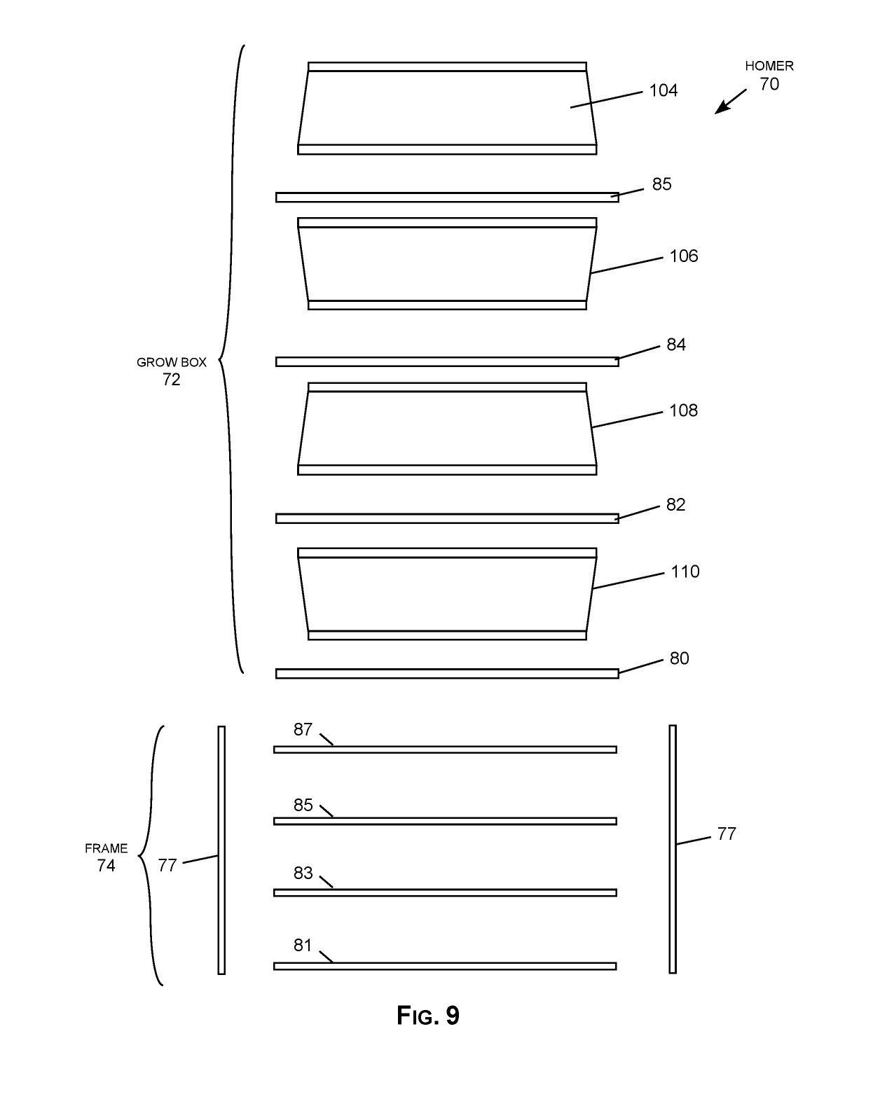

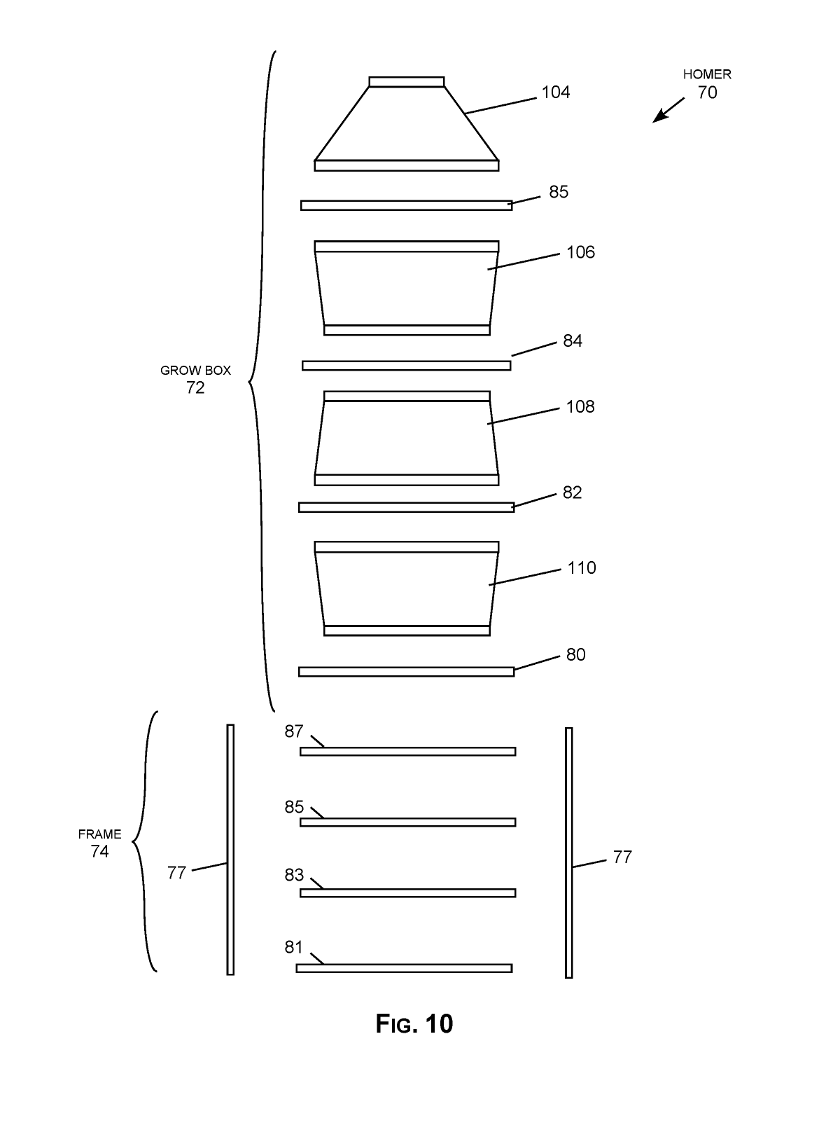

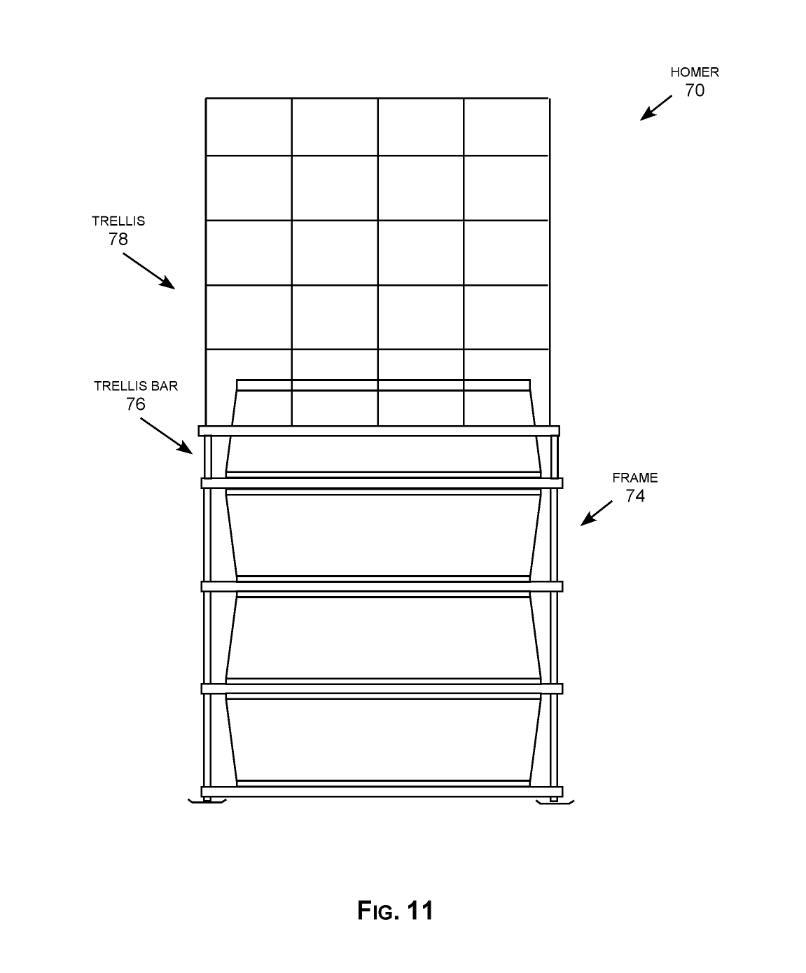

FIG. 7 is a side view of one particular version of the Homer unit 70 that includes a four chamber grow box 72, as described previously, held together by a frame 74. FIG. 8 is an end view of this version of the Homer unit 70. FIG. 9 is a side assembly view of the Homer unit 70 and FIG. 10 is an end assembly view of the unit. This embodiment is shown approximately to scale in FIGS. 7-8 with the width of 40 inches (102 cm) shown in FIG. 7 and the depth of 24 inches (61 cm) shown in FIG. 8. In this version, the grow box may be constructed from four high density foam containers. Alternatively, the containers may be hard-sided foam chambers, similar to a typical drink cooler, constructed through an over-molding process. The frame 74 may be made from a variety of materials. One-inch (2.5 cm) aluminum extrusion typically used to construct aluminum swimming pool enclosures or one and a half inch (4 cm) PVC pipe have been found to be suitable frame materials. In this version, the posts 77 of the frame 74 extend through holes in four shelves 80-86 that are placed below the chambers of the grow box 70. Each shelf 80-86 rests on respective crossbars 81-87 of the frame 74 and each chamber 110-104 is supported by a respective shelf. The side walls of shelf chases add rigidity to the shelf. The frame may be supported by foot plates 76 to keep the frame from digging into the ground and facilitate sliding the unit. As an option, the foot plates may be replaced by casters.

Each shelf has two chases, one configured to receive a lip around the top (larger) edge of the chambers 110-104, and a configured to receive a lip around the bottom (smaller) edge of the chambers. Each shelf includes these chases on both sides so that the shelf can support chambers on both sides of the shelf. The shelf 80 at the bottom of the supports the pump tank 110 a sufficient distance above the ground to facilitate draining of the unit. To provide adequate support, the bottom shelf 80 may not have cutouts and may be supported by a central frame crossbar. The shelf 82 between the pump tank 110 and the control section 108 has a number of cutouts including holes for the bell siphon, the water supply tube, the air tube and electrical wires. The shelf 82 also includes a nutrient hatch and a door large enough to allow the pump and aerator (e.g., air stone) to be removed from the pump tank 110 without disassembling the unit. The shelf 84 between the control section 108 and the ebb-and-flow section 106 also has a number of cutouts including holes for the bell siphon and water supply tubes extending from the pump tank into the ebb-and-flow section. The shelf 86 between the ebb-and-flow section 106 and the topper 104 includes a large central cutout allowing the grow sleeves to extend from the topper into the ebb-and-flow section 106. This cutout may be used to create the root raft that floats in the ebb-and-flow section. Note that the topper 104 may have a different shape from the other chambers of the grow box 72. In general, a number of different toppers with different shapes designed for different types of plants, and combinations of plants, may be available.

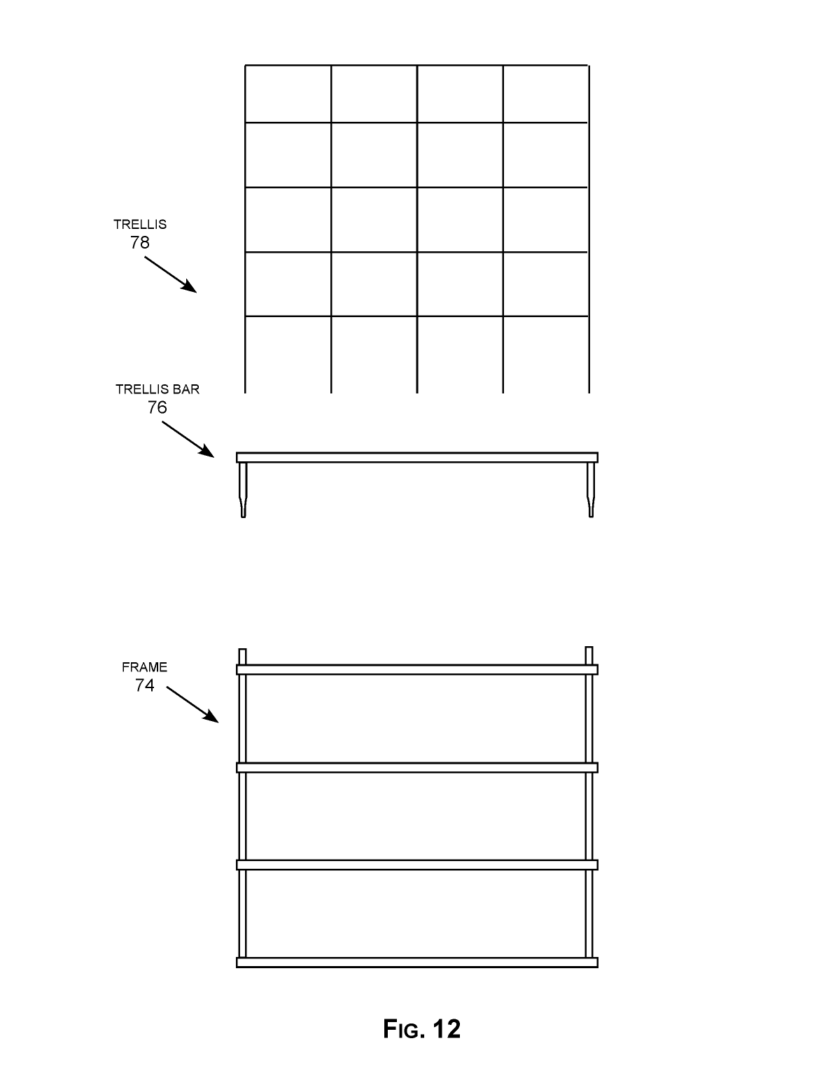

FIG. 11 is a side view of the Homer unit 70 including a trellis attachment. FIG. 12 is an assembly side view of the trellis attachment. This particular trellis attachment includes a trellis bar 76 that fits into the top of the frame 74 and a wire trellis 76 that fits into holes in the trellis bar. The unit may have a pair of trellis bars and two trellis sections attached to each other at their top ends forming an “A” frame above the trellis bars. As another option, the top crossbars of the frame 74 may serve as the trellis bars.

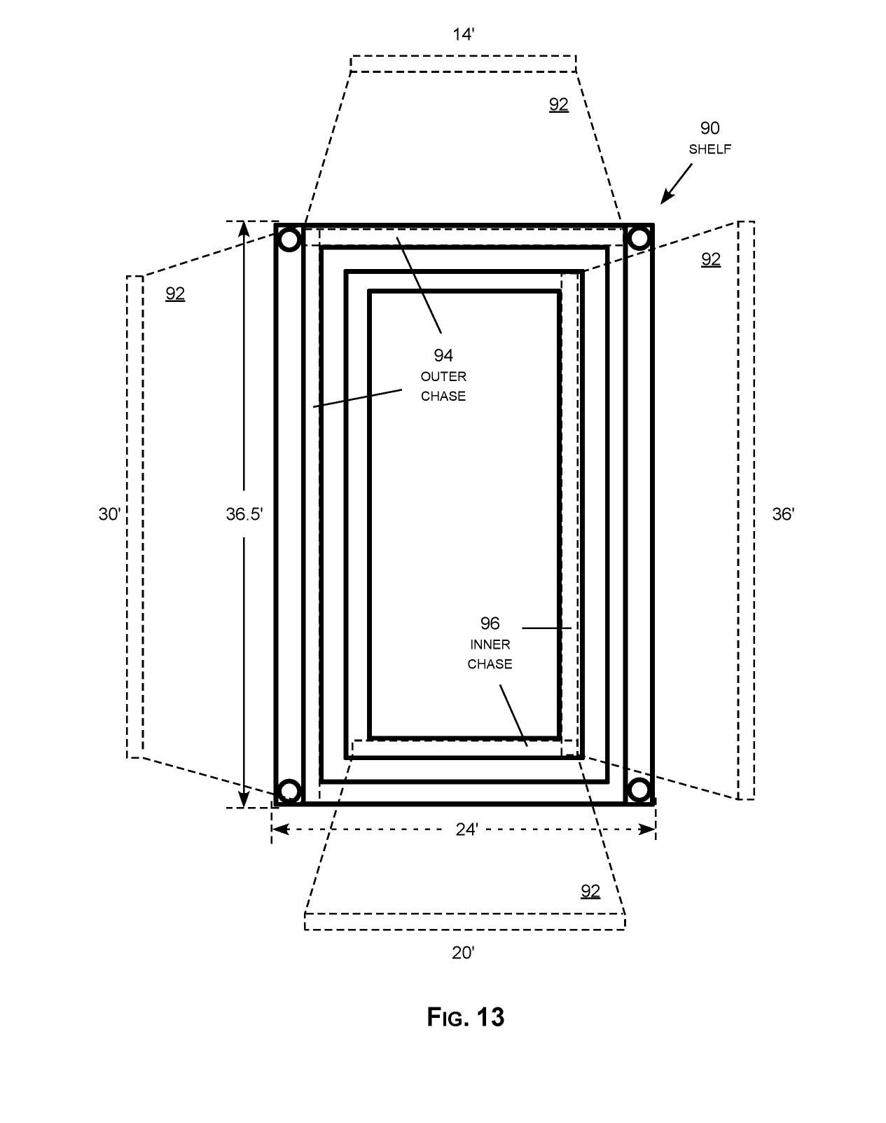

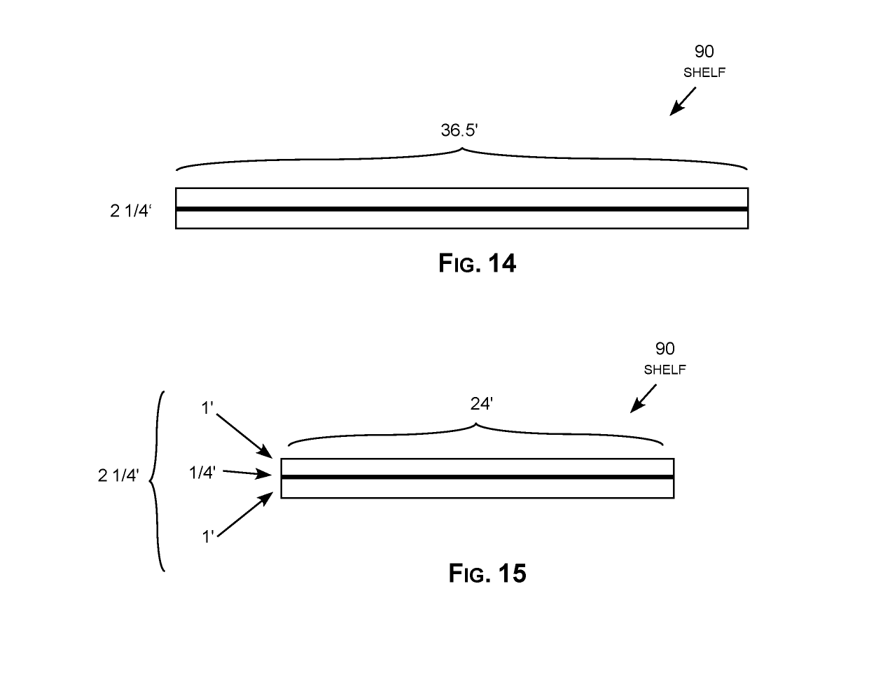

FIG. 13 is conceptual top view of a particular type of shelf 90 for the Homer unit. FIG. 14 is conceptual side view of the shelf and FIG. 15 is conceptual end view of the shelf. Dimensions shown in inches for this particular version of the shelf are shown on the FIGS. 13-15. The shelf is designed to be universal so that the same shelf can be used in each shelf location in the unit. FIG. 13 conceptually illustrates how a representative chamber 90 fits into the chases. The shelf 90 has two chases, an outer chase 94 configured to receive a lip around the top (larger) edge of a representative chamber 90, and an inner case 96 configured to receive a lip around the bottom (smaller) edge of chamber 90. The shelf 90 includes these chases on both sides so that the shelf can support chambers on both sides of the shelf. The side walls of the chases add rigidity to the shelf.

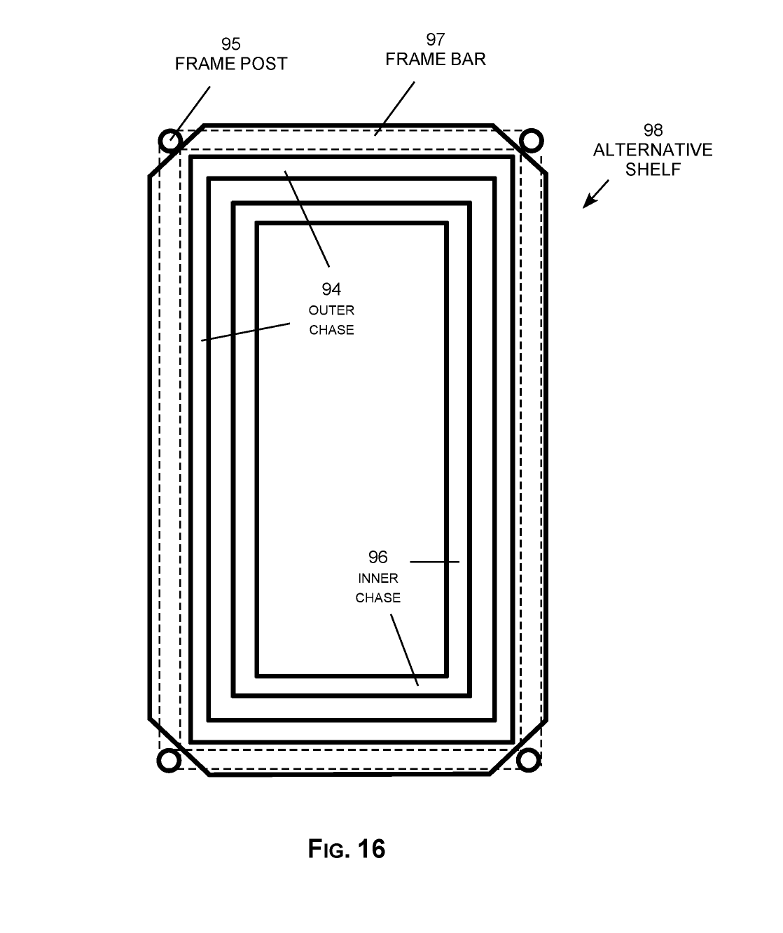

FIG. 16 is conceptual top view of an alternative shelf 98 for the Homer unit. Rather than including holes to receive the frame posts, the alternative shelf 98 includes beveled corners that allow the shelf to be positioned adjacent to the frame posts 95 with overhangs that allow the shelf to sit on top of the frame crossbars 97. This configuration makes it easier to remove shelves and containers form the grow unit without having to disassemble the frame.

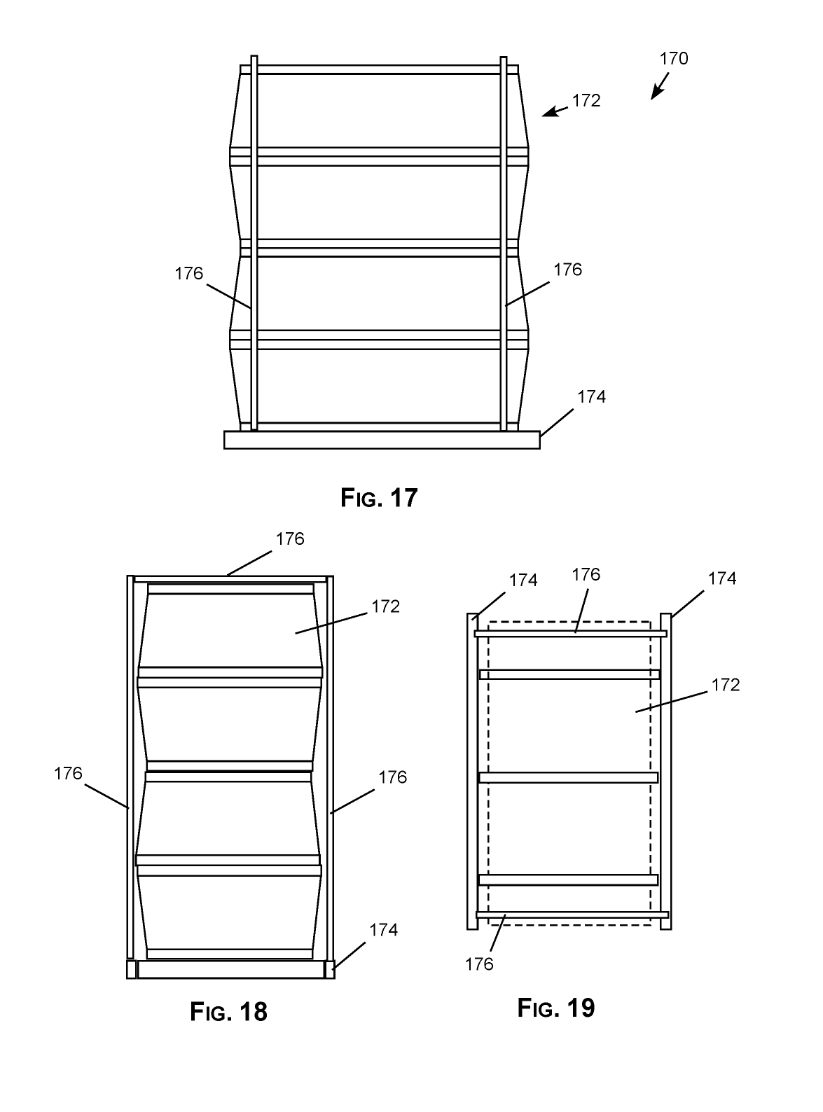

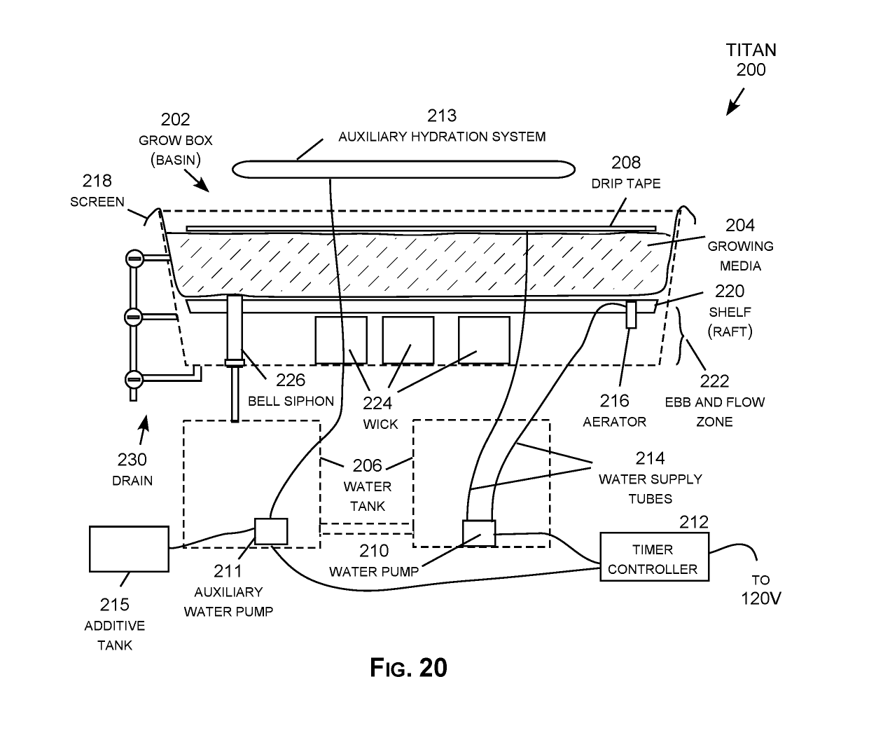

FIG. 17 is a side view conceptual diagram of another illustrative embodiment of the Homer unit 170. FIG. 18 is an end view and FIG. 19 is a top view of this particular version of the Homer unit 170. For an option, the chambers 172 of this version of the Homer unit may be appropriately sized “fish boxes” typically used to store and ship aquarium fish. The fish boxes may be specially manufactured at higher density than normal for this purpose. As one specific example, the chambers of a particular version of the Homer unit may be four high density (2.8 lbs.) foam boxes provided by Speedling, Inc. of Ruskin, Fla. (GPS II Fish Box, 26″×18″×11−½″, ⅞″ wall thickness, nesting box) (66 cm×46 cm×29 cm, 2.2 cm wall thickness, nesting box). The water pump, air pump, fittings, timer, and tubing are all commercially available products. A simple frame may be used to support the unit a small distance off the ground to facilitate draining and prevent the unit from being easily knocked over. In this particular version, the frame may be constructed from a simple “2 by 4” (5 cm×10 cm) lumber base 174 and two vertical U-sections 176 constructed from one-inch (2.5 cm) PVC pipe extending from the base over the top of the unit. The vertical sections of PVC U-sections 176 may fit loosely into holes drilled into the lumber base 174 or brackets attached to the lumber base for easy removal. This version of the Homer unit will hold about 8 gallons (30 liters) of water in normal operation. As a closed container design, the Homer unit will experience lower evaporative water loss that open-top designs, such as the second type of hybrid hydroponic unit described below.

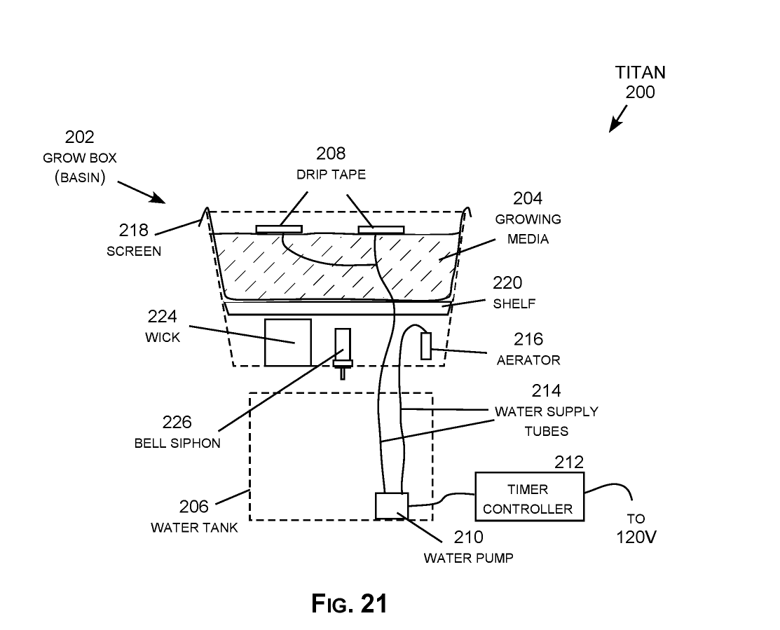

FIG. 20 is a side view conceptual diagram of a second type of hybrid hydroponic unit known as the “Titan” hybrid hydroponic unit 200. FIG. 21 is an end view conceptual diagram of the Titan unit. The Titan unit is designed to support about the same number of plants as two Homer units while holding five times the water and about ten times the growing media. This is expected to provide ease-of-use operational benefits due to the larger water storage and growing media volumes. In particular, the Titan unit is designed to minimize if not obviate the need for water flushing during a growing season.

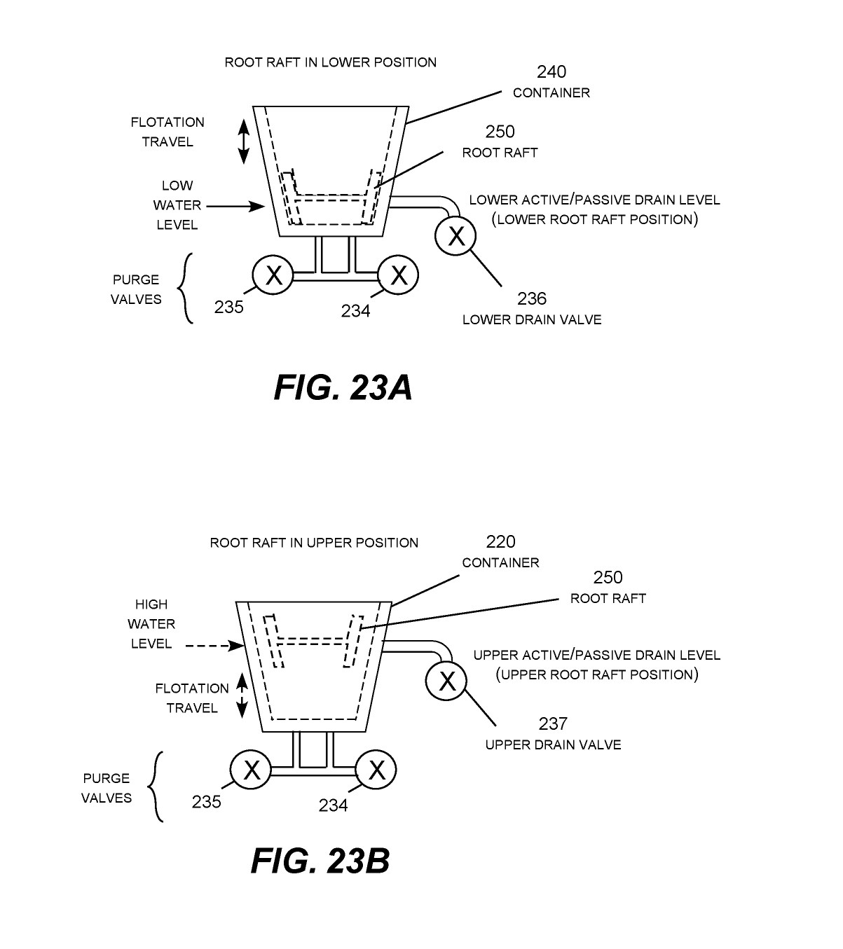

The Titan unit 200 is a simplified version of the Homer device having many of the same attributes in a larger unit accommodating larger amounts of growing media and recirculating water. The Titan unit includes an elongated grow box or basin 202 holding growing media 204, which may be ten foot cattle feed bunker. Two 30 gallon (114 liter) trash cans serve as pump tanks connected by a conduit near the bottom of the tanks forming the pump tank reservoir 206. Drip tape 208 fed by a water pump 210 in the pump tank supplies water via water tubes 214 to the drip tape (typically intermittently) to hydrate the young plants at the top of the media basin 202. A timer-controller 212 controls the operation of the water pump 210. The water pump 210 also supplies water to the basin 212 through a diffuser (aerator) 216. A screen 218 holds the growing media 204 above a shelf 220 near the bottom of the basin. The shelf 220 may be fixed or it may be a raft floating on an ebb-and-flow zone 222 in the bottom portion of the basin 202. Dutch wicks 224 may be located below the shelf 220. In addition to the drip tape irrigation, water is pumped from one of the pump tanks into the bottom of the basin, where it flows across the basin toward a drain above the other pump tank. A bell siphon 226 may be installed in the basin to create ebb-and-flow hydration in an ebb-and-flow zone 222 in the basin 202, while the Dutch wicks 224 facilitate hydration to plant roots as they reach the bottom of the growing media 204. The basin 202 also includes a regulated drain for purging the water from the basin. This may be a simple purge valve or a more sophisticated active-passive, three-level drain 230 as described in greater detail with reference to FIGS. 23 and 24A-24B.

As another option, the Homer or Titan units may include a second water pump represented by the auxiliary water pump 211 shown in FIG. 20. The auxiliary water pump 211 provides redundancy and flexibility to the system and may be used for a variety of purposes. In this example, the auxiliary water pump 211 supplies an auxiliary hydration system 213, such as an aeroponic, aerosol or water emitter positioned to spray the growing foliage. For example, the auxiliary water pump 211 may be used to apply an additive stored in an additive tank 215 to the plants growing in the system.

In the Titan unit 200, the seedlings may be individually irrigated by the drip tape or other suitable emitters. As the plants grow, they reach down into the layer of growing media. The growing media may be irrigated by a transverse flow of water or continually ebb-and-flow flooded and drained by way of the bell siphon. As in the Homer unit, an active passive drain system is employed. The Dutch wicks further aid in the transfer of the water up from the basin to the plant roots. In the final stage of plant growth, the roots have the ability to extend through the ebb and flow zone, through the media screen, and into the bottom of the basin where aerated water is present. This provides a deep water culture for mature plants.

The Titan unit holds up to 40 gallons (151 liters) of water in normal operation. It should be noted that the Titan unit is designed to support the same number of plants as two Homer units while holding about five times the water and ten times the growing media. This is expected to minimize if not obviate the need for water flushing during a growing season.

In a particular embodiment, the grow box basin of the Titan unit may be a ten foot cattle feed bunker (10′×32″×18″ pan depth 9″) (3m×1m×0.5m pan depth 23 cm). Two 30 gallon (114 liter) plastic trash containers connected by a two inch (5.1 cm) PVC conduit near the bottom of the tanks may provide the pump tank reservoir. The screen, water pump, air pump, timer, fittings, wicks, and tubing are all commercially available products. The stand may be constructed from two saw horses. This version of the Titan unit will hold up to 40 gallons (151 liter) of water in normal operation. Note that FIGS. 20-21 are not shown to scale for a ten-foot (3 meter) grow box basin, which is relatively longer than depicted in the conceptual illustrations.

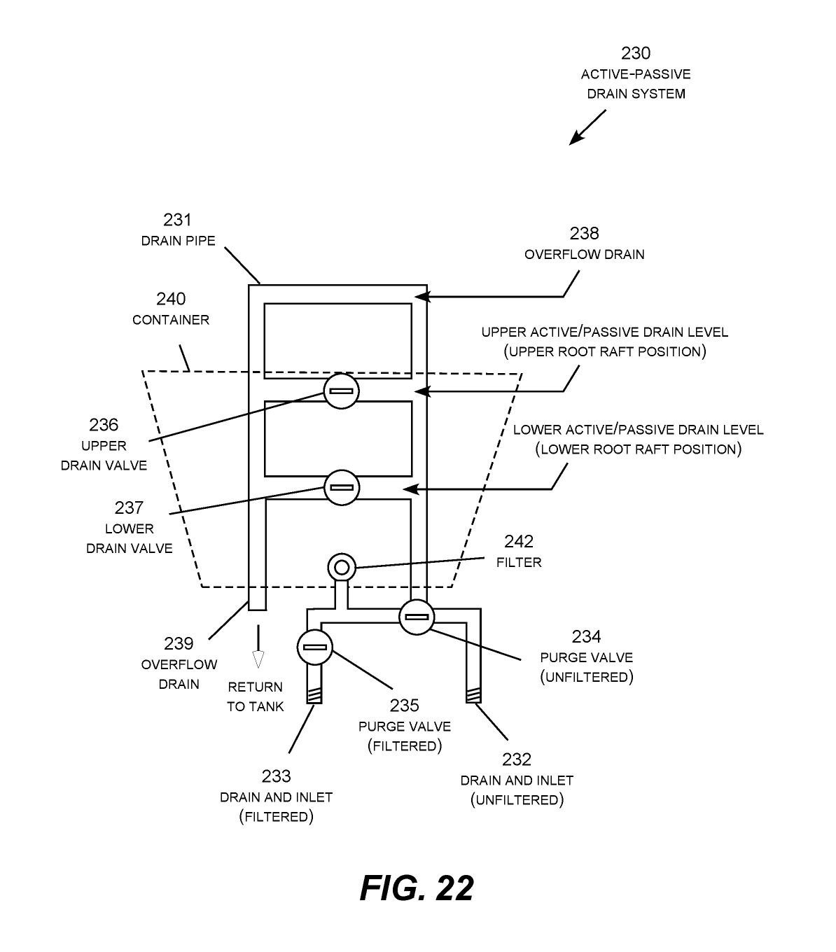

FIG. 22 is a conceptual illustration of a three-stage drain system 230, which is also referred to as an “active-passive” drain system, shown connected to an illustrative container 240 of the hybrid hydroponic system. In various embodiments, the three-stage drain 230 may be connected to an ebb-and-flow container and/or a pump tank. The active/passive drain is particularly useful when connected to an ebb-and-flow container, such as the ebb-and-flow container 108 of the Homer unit 100 shown in FIGS. 1-2 or the grow box (basin) 202 of the Titan unit 200 shown in FIGS. 20-21.

The container 240 includes a looped drain pipe 231 connected to a filter 242 at the bottom of the container and an unregulated overflow exit pipe 239. The drain pipe 231 includes a first drain-inlet coupler 232 that can be used to fill or drain the container 240 without going through a filter. The drain pipe 231 also includes a second drain-inlet coupler 233 that can be used to fill or drain the container 240 through the filter 242. The drain system 230 can be used for a number of purposes including, for example, cleaning the filter 242 by back-feeding water into the container through the drain-inlet coupler 233. The bottom drain-inlet 232 can be used to fill or empty the container 240 without going through the filter 242. The unfiltered drain-inlet 232 is regulated by a purge valve 234, while the filtered drain-inlet 233 is regulated by a valve 235. The drain pipe 231 includes two additional drain valves, an upper drain valve 236 and a lower drain valve 237. The upper drain valve 236 is connected to a drain pipe extending into the container 240 at the level of the upper drain valve 236. Similarly, the lower drain valve 237 is connected to a drain pipe extending into the container 240 at the level of the lower drain valve 237. The drain pipe 231 further includes an overflow (passive) drain 238 connected to a drain pipe extending into the container 240 at the level of the drain 238 that vents through the unregulated exit pipe 239, which typically returns any overflow water to the pump tank.

The upper drain valve 236 allows the container 240 to be drained to the level of the upper drain valve 236 when the upper valve 236 is opened with the valves 234, 235 and 237 closed. The lower drain valve 237 allows the container to be drained to the level of the lower drain valve 237 when the lower valve 237 is opened with the valves 234 and 235 closed. The purge valve 234 is connected to a drain pipe in the bottom of the container allowing the water and any sediment in the container to be drained when the valve 234 is opened. This arrangement allows the container 240 to be cleaned through the drain-inlet 233 with the valves 234 and 235 open to clean the filter 242 and wash any sediment dislodged from the filter through the drain-inlet 232. This container may be filled through the drain-inlet 233 and the filter 242 with the valve 235 open and the valve 234 closed. This container may be filled through the drain-inlet 232 without going through the filter 242 with the valve 234 open and the valve 235 closed. This arrangement can be used to fill the container to the level of either drain valve 236 or 237 or the overflow 238 depending on the open or closed states of the drain valves 236 and 237. The levels of the upper and lower drain valves 236 or 237 may correspond to upper and lower flotation levels of a root raft, and described below with reference to FIGS. 23A and 23B.

FIGS. 23A and 23B illustrate floatation travel of a root raft 250 within the representative container 240. In normal operation the upper drain valve 236 is left open with the lower drain valve 237 and purge valves 234 and 235 closed. This allows the root raft 250 to experience flotation travel between the lower level shown in FIG. 23A and the upper level shown in FIG. 23B in response to changing water levels in the container 240. This causes the root raft to float on a deep water culture below the raft, where it is occasionally hydrated when the pump is activated with the water draining into the deep water culture below the root raft. This encourages small root proliferation above the root raft as well as tap root infiltration through the root raft into the deep water culture. The lower drain valve 236 can be opened with the purge valves 234 and 235 closed to force the root raft to the lower level shown in FIG. 23A. Similarly, the upper drain valve 237 may be closed with the upper drain valve 236 open, with a supply hose connected to one of the purge valves 234 and 235, to drive the root raft to the upper position shown in FIG. 23B. The container 240 may also be filled from either of the purge valves 234 and 235 with the valves 236 and 237 closed to overfill the container 240. This inundates the rhizome in the container 240 to initiate an ebb and flow hydration cycle. In this embodiment, the root raft 250 has an H-shape to prevent the rhizome on top of the root raft from getting smashed against the container lid during ebb and flow cycling. Either purge valve 234 or 235 may be opened to evacuate the water from the container 240 to change the solution in the container. The purge valve 234 vents the water through the filter 242, while the purge valve 235 vents the water without going through the filter 242. The three-stage drain system 230 thus gives an operator a great deal of control over hydration of the rhizome in the root box.

Many other potential features and variations will become apparent to those skilled in the art one they become familiar with the basic element of the invention. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The invention is defined by the following claims, which should be construed to encompass one or more structures or function of one or more of the illustrative embodiments described above, equivalents and obvious variations.

The invention claimed is:

1. A hybrid hydroponic plant growing unit, comprising:
one or more nutrient solution containers configured to hold a supply of nutrient solution for fertilizing and hydrating one or more plants;
one or more growing media containers configured to hold soil or soil-like growing media and one or more plants growing in the growing media;
a water pump for recirculating the nutrient solution between the nutrient solution containers and the growing media containers;
a combination of irrigation devices configured to apply the nutrient solution to plants growing in the growing media containers selected from the group including drip system, nutrient wicking, ebb-and-flow, and deep water culture;
wherein the growing media containers, the nutrient solution containers, and the irrigation devices are physically connected to each other to form an integral hybrid hydroponic plant growing unit.

2. The hybrid hydroponic plant growing unit of claim 1, wherein;
the one or more growing media containers comprise a plurality of air pruning grow sleeves; and
the irrigation devices comprise direct injection drip irrigation devices configured to supply the nutrient solution to the irrigation devices.

3. The hybrid hydroponic plant growing unit of claim 2, wherein;
the one or more nutrient solution containers comprise an ebb-and-flow container positioned below the grow sleeves; and
the irrigation devices comprise a bell siphon in the ebb-and-flow container configured to cause the nutrient solution to periodically rise and fall within the ebb-and-flow container.

4. The hybrid hydroponic plant growing unit of claim 2, where in the irrigation devices further comprise one or more water spray emitters positioned to spray onto the one or more grow sleeves.

5. The hybrid hydroponic plant growing unit of claim 3, wherein the irrigation devices further comprise one or more water spray emitters positioned to spray onto the one or more grow sleeves.

6. The hybrid hydroponic plant growing unit of claim 5, wherein:
the one or more nutrient solution containers further comprise a pump tank positioned below the ebb-and-flow container; and
the water pump is located within the pump tank.

7. The hybrid hydroponic plant growing unit of claim 6, further comprising an aerator located in the pump tank.

8. The hybrid hydroponic plant growing unit of claim 7, further comprising a controller section located between the ebb-and-flow container and the pump tank housing a timer-controller operationally connected to the water pump and an air pump operationally connected to the aerator.

9. The hybrid hydroponic plant growing unit of claim 1, further comprising a water supply valve and a level switch automatically controlling a supply of water to the pump tank.

10. The hybrid hydroponic plant growing unit of claim 1, further comprising a timer-controller operationally connected to the water pump.

11. The hybrid hydroponic plant growing unit of claim 10, further comprising a water heater-chiller timer-controller operationally connected to the timer-controller.

12. The hybrid hydroponic plant growing unit of claim 10, further comprising an air circulation fan operationally connected to the timer-controller.

13. The hybrid hydroponic plant growing unit of claim 10, further comprising a nutrient supply operationally connected to the timer-controller.
